(19) United States
(12) Patent Application Publication
(10) Pub. No.: US 2006/0016084 A1
(43) Pub. Date: Jan. 26, 2006

(54) Laser-Based datum instrument

(76) Inventors: Ching-Lin Liao, Ta Li City (TW); Chiu-Man Chang-Kao, Taichung Hsien (TW)

Correspondence Address: CHARLES E. BAXLEY, ESQ., 90 JOHN STREET, THIRD FLOOR, NEW YORK, NY, 10038, US

(21) Appl. No.: 10/897,894

(22) Filed: Jul. 24, 2004

(51) Int. Cl. G01C 15/00

(52) U.S. Cl. 33/286

(57) ABSTRACT

A laser-based datum instrument is disclosed. The laser-based datum instrument includes a holder for attachment to an external object. A swinging device is rotationally connected with the holder. At least one laser source is attached to the swinging device. The laser source casts a laser beam for providing a datum line.

### BACKGROUND OF INVENTION

1. Field of Invention

The present invention relates to a laser-based datum instrument.

2. Related Prior Art

Referring to FIG. 8, a conventional laser-based leveling instrument includes a body 101, a leveling rod 111 installed on the body 101, magnets 112 provided at the bottom of the body 101, an ear 113 formed at an end of the body 101, an aperture 114 defined in the ear 113, a laser source 102 provided at an end of the body 101 and a switch 120 installed on the body 101. Referring to FIG. 9, the laser-based leveling instrument is used together with a datum 103. By means of the leveling rod 111, the datum 103 is made perfectly horizontal. If the datum 103 is made of steel, the laser-based leveling instrument will be kept on the datum 103 by means of the magnets 112. The laser source 102 can be turned on by means of the switch 120. A laser beam is cast onto an object 104 from the laser source 102. A light spot 121 is cast on the object 104. A mark can be made on the object 104 where the light spot 12L is. The body 101 can be rotated on the datum 103 around the aperture 114. Thus, more light spots are cast onto the object 104 and more marks can be made on the object 104 on a same level. Referring to FIG. 10, the laser-based leveling instrument is used together with a stand 105. A tip of the stand 105 is inserted in a hole 115 defined in the bottom of the body 101. By means of the leveling rod 111, the tip of the stand 105 is made perfectly vertical. Thus, the laser beam can scan on a same level. The laser-based leveling instrument involves a complicated and difficult operation because it must be used together with the datum 103 or the stand 105, and because the datum 103 must be made perfectly horizontal or the tip of the stand 105 must be made perfectly vertical by means of the leveling rod 111.

The present invention is therefore intended to obviate or at least alleviate the problems encountered in prior art.

### SUMMARY OF INVENTION

According to the present invention, a laser-based datum instrument includes a holder for attachment to an external object. A swinging device is rotationally connected with the holder. At least one laser source is attached to the swinging device. The laser source casts a laser beam for providing a datum line. The rotational connection of the swinging device with the holder and the attachment of the laser source to the swinging device ensure that the laser beam cast by the laser source travels in a pre-determined direction. The operation of the laser-based is simple and easy.

Other objects, advantages, and novel features of the invention will become more apparent from the following detailed description when taken in conjunction with the attached drawings.

### BRIEF DESCRIPTION OF DRAWINGS

The present invention will be described through detailed illustration of the preferred embodiment referring to the drawings.

FIG. 1 is a perspective view of a laser-based datum instrument according to the preferred embodiment of the present invention.

FIG. 2 is an exploded view of the laser-based datum instrument shown in FIG. 1.

FIG. 3 is a cross-sectional view of the laser-based datum instrument shown in FIG. 1.

FIG. 4 is a perspective view of the laser-based datum instrument shown in FIG. 1 hung on a wall.

FIG. 5 is a cross-sectional view of the laser-based datum instrument shown in FIG. 1 and shows the laser-based datum instrument casting a level datum line.

FIG. 6 is similar to FIG. 5 but shows the laser-based datum instrument in another position and a swinging device in oscillation.

FIG. 7 is similar to FIG. 6 and shows the laser-based datum instrument casting a vertical datum line.

FIG. 8 is a perspective view of a conventional laser-based datum instrument.

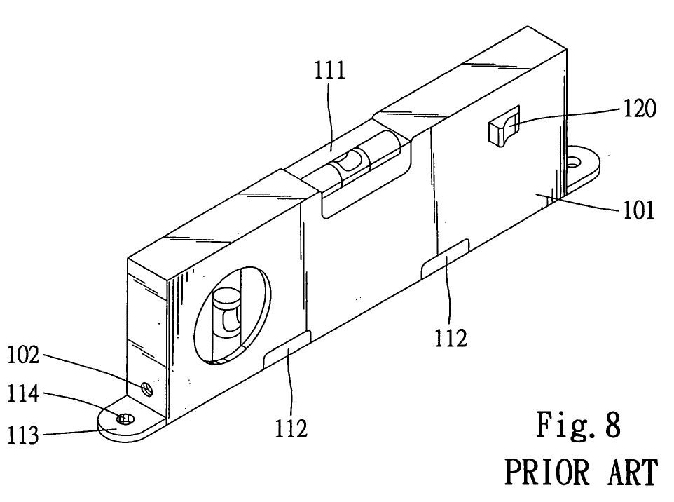

FIG. 9 is a side view of the conventional laser-based datum instrument shown in FIG. 8 used together with a datum.

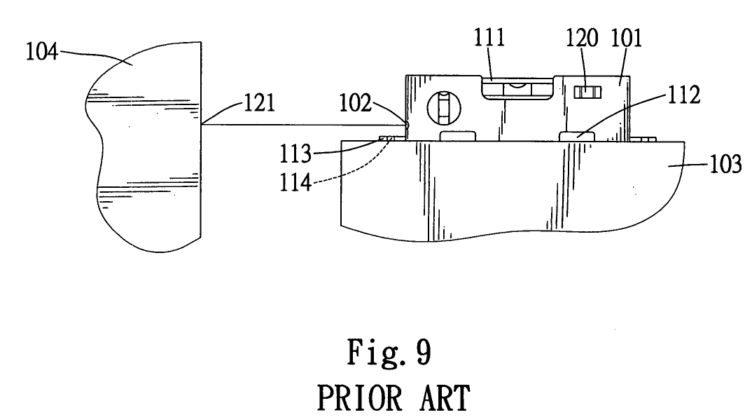

FIG. 10 is a side view of the conventional laser-based datum instrument shown in FIG. 8 used together with a stand.

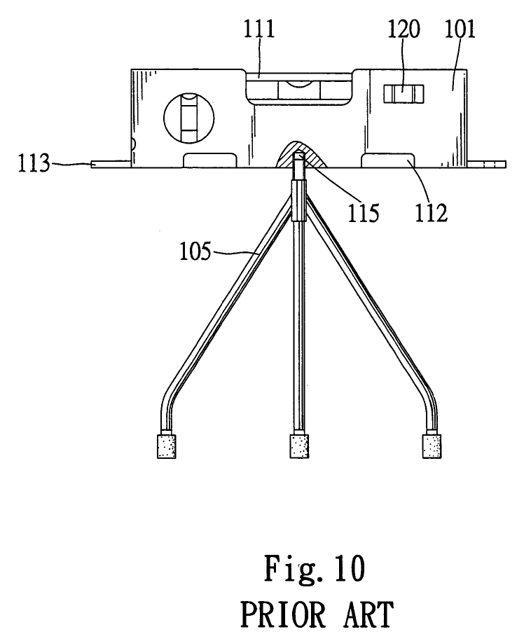

### DETAILED DESCRIPTION OF PREFERRED EMBODIMENT

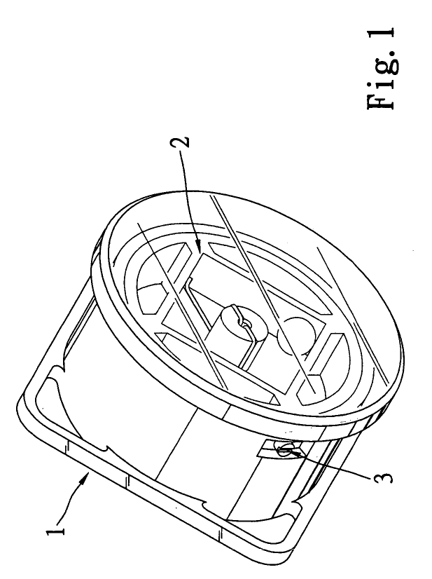

FIG. 1 shows a laser-based datum instrument according to the preferred embodiment of the present invention.

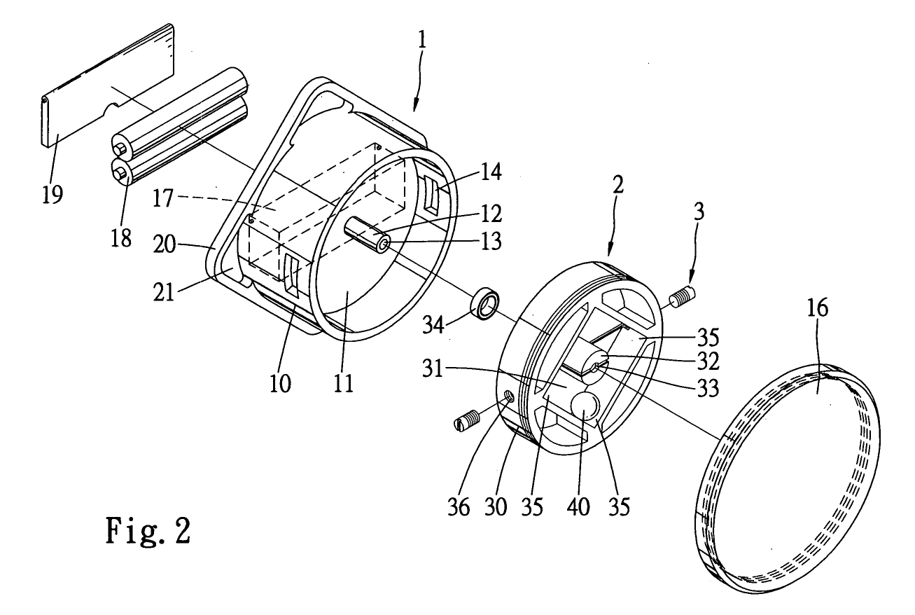

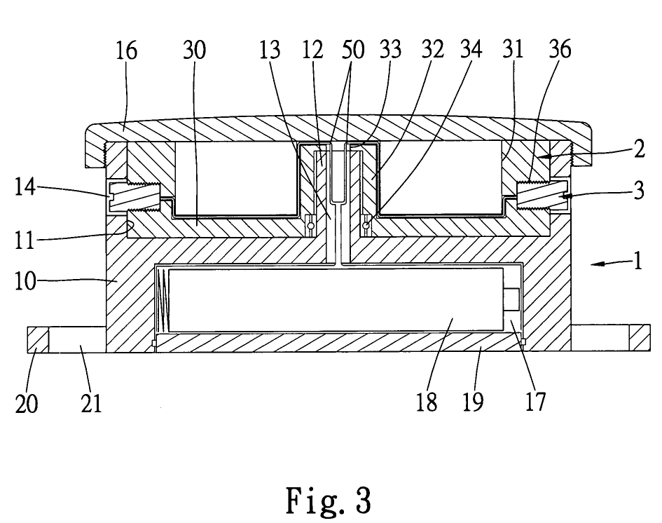

Referring to FIGS. 2 and 3, the laser-based datum instrument includes a holder 1, a swinging device 2 and two laser sources 3. The holder 1 includes a drum 10 and a plate 20 on which the drum 10 is formed. The drum 10 defines a front space 11 on a front side and a rear space 17 on a rear side. The drum 10 includes a shaft 12 formed on the front side. The shaft 12 includes a passage 13 defined therein. The rear space 17 is used for receiving two batteries 18. The rear space 17 is communicated with the front space 11 through the passage 13. The space 17 is closed by means of a rear cover 19. The drum 10 includes two slots 14 each defined in one side thereof. Each slot 14 includes two ends 15. The plate 20 is square. The plate 20 includes four apertures 21 each defined in one of the corners thereof.

The swinging device 2 includes a rim 30 and a weight 40. The rim 30 includes a space 31 defined therein and a hub 32 formed in the space 31. The space 31 includes a square configuration, i.e., it includes four walls and four corners 35. The hub 32 defines an aperture 33 at the tip. The rim 30 defines two holes 36 on the periphery.

The rim 30 is put in the drum 10. The hub 32 is put around the shaft 12. A bearing 34 is provided between the hub 32 and the shaft 12. Thus, the swinging device 2 is rotationally put in the holder 1.

Each laser source 3 is put in a corresponding hole 36 of the rim 30 through a corresponding slot 14 of the drum 10. Wires 50 are directed from the rear space 17 of the drum 10 to the space 31 of the rim 30 through the passage 13 and the aperture 33. Power is provided to the laser sources 3 from the batteries 19 through the wires 50. Thus, each laser source 3 can emit a laser beam. Each laser beam passes through a corresponding slot 14.

The weight 40 is a steel ball put in selective one of the corners 35. The weight 40 provides a function of stopping oscillation when the swinging device 2 oscillates relative to the holder 1. The front space 11 of the drum 10 is closed by means of a transparent cover 16.

Although not shown, the holder 1 can be installed a switch (not shown) for controlling the laser source 3 is turned on or off. The switch will not be described in detail for being conventional.

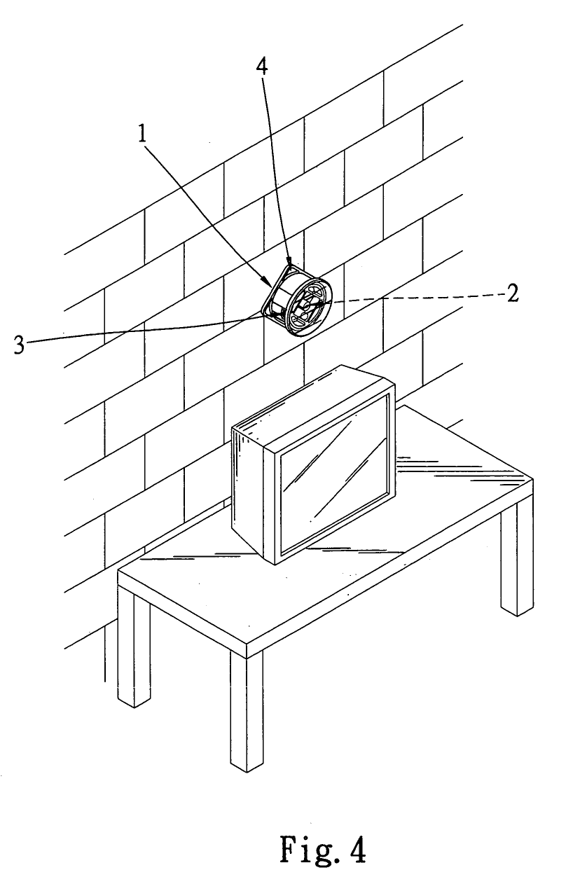

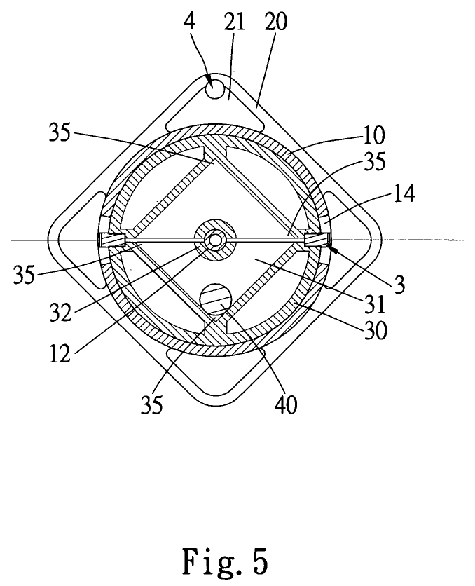

Referring FIGS. 4 and 5, the laser-based datum instrument is hooked on a hook 4 secured to a wall. The hook 4 is inserted through selective one of the apertures 21 (see FIG. 2). Referring to FIG. 5, the laser sources 3 cast laser beams passing in two opposite senses of a horizontal direction, i.e. on a same level so as to form a level (or “horizontal”) datum line.

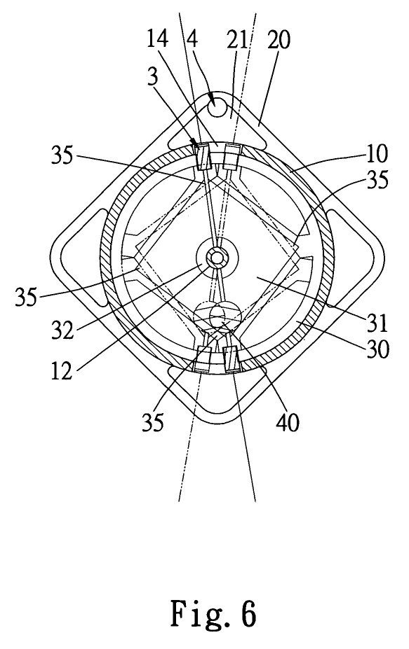

FIG. 6 shows the laser-based datum instrument hung on the wall in oscillation. Each laser source 3 is reciprocating in a related slot 14. The movement of each laser source 3 is limited between the ends 15 of a related slot 14, i.e., each laser source 3 is only allowed to move in a small range. Because of the weight 40 rolling in one of the corners 35, the oscillation of the swinging device 2 relative to the holder 1 will come to an end eventually.

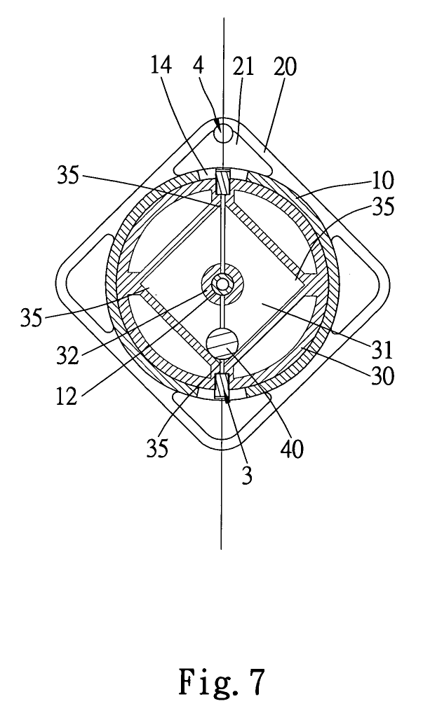

FIG. 7 shows the laser-based datum instrument hung on the wall in a still state. The laser sources 3 cast two laser beams in two opposite senses of a vertical direction so as to form a vertical datum line.

The present invention has been described through detailed illustration of the preferred embodiment. Those skilled in the art can derive variation from the preferred embodiment without departing from the scope of the present invention. Therefore, the preferred embodiment shall not limit the scope of the present invention defined in the claims.

1. A laser-based datum instrument comprising a holder, a swinging device rotationally connected with the holder and at least one laser source attached to the swinging device for casting a laser beam for providing a datum line.

2. The laser-based datum instrument according to claim 1 wherein the swinging device comprises a rim rotationally connected with the holder and a weight put in the rim.

3. The laser-based datum instrument according to claim 2 wherein the weight is a ball with adequate weight.

4. The laser-based datum instrument according to claim 2 wherein the rim defines a space for receiving the weight.

5. The laser-based datum instrument according to claim 4 wherein the space includes at least one corner for receiving the weight.

6. The laser-based datum instrument according to claim 5 wherein the space comprises two corners separated from each other by a right angle.

7. The laser-based datum instrument according to claim 5 wherein the space comprises four corners separated from one another by a right angle.

8. The laser-based datum instrument according to claim 1 wherein the laser source cast the laser beam in a horizontal direction.

9. The laser-based datum instrument according to claim 1 wherein the laser source cast the laser beam in a vertical direction.

10. The laser-based datum instrument according to claim 1 comprising two laser sources for casting laser beams in two opposite senses of a datum direction.

11. The laser-based datum instrument according to claim 10 wherein the laser sources cast laser beams in opposite senses of a horizontal datum direction.

12. The laser-based datum instrument according to claim 10 wherein the laser sources cast laser beams in opposite senses of a vertical datum direction.

13. The laser-based datum instrument according to claim 1 wherein the laser source casts the laser beam in selective one of horizontal and vertical directions.

14. The laser-based datum instrument according to claim 2 wherein the rim defines a hole in the periphery for receiving the laser source.

15. The laser-based datum instrument according to claim 2 wherein the holder comprises a drum for receiving the rim.

16. The laser-based datum instrument according to claim 2 wherein the holder comprises a shaft formed thereon, wherein the rim comprises a hub for receiving the shaft.

17. The laser-based datum instrument according to claim 16 comprising a bearing between the shaft and the hub.

18. The laser-based datum instrument according to claim 1 wherein the drum includes two slots each defined in one side thereof for receiving related one of the laser sources.

19. The laser-based datum instrument according to claim 18 wherein each of the slots includes two ends for restricting the movement of related one of the laser sources.

20. The laser-based datum instrument according to claim 1 wherein the swinging device comprises a square plate with an aperture defined in each of the corners of the square plate.
